(19) United States
(12) Patent Application Publication
(10) Pub. No.: US 2013/0346335 A1
(43) Pub. Date: Dec. 26, 2013

(54) DETERMINING COURSE EQUIVALENCE

(71) Applicant: CourseMaven, Leesburg, VA (US)

(72) Inventor: Janet Marie Van Pelt, Leesburg, VA (US)

(73) Assignee: CourseMaven, Leesburg, VA (US)

(21) Appl. No.: 13/895,026

(22) Filed: May 15, 2013

Related U.S. Application Data
(63) Continuation of application No. 13/776,593, filed on Feb. 25, 2013.
(60) Provisional application No. 61/661,822, filed on Jun. 20, 2012.

(51) Int. Cl. G06Q 50/20

(52) U.S. Cl. CPC G06Q 50/205; G06Q 10/063
USPC 705/326

(57) ABSTRACT

Embodiments disclosed herein provide systems and techniques for determining, manipulating, and providing indications of equivalence for courses at and among institutions of higher education. Embodiments may be used to calculate and assign various scores and metrics to one or more course which allow for automated determination of whether a proposed equivalent course should be accepted as an equivalent of a base course at an institution.

### CROSS-REFERENCE TO RELATED APPLICATIONS

This application is a continuation of U.S. application Ser. No. 13/776,593, filed Feb. 25, 2013, which claims priority to U.S. Provisional Patent Application Ser. No. 61/661,822, filed Jun. 20, 2012, the disclosure of each of which is incorporated by reference in its entirety.

### BACKGROUND

Credit transfer and articulation, defined as the ability for institutions of higher education to properly award credit to incoming students for courses completed at another institution, has been a long-standing problem for both students and institutions and is increasing in urgency and visibility. With rising tuition rates, students need the ability to plan their educational path to meet goals such as reduced cost or shortest time to a particular degree which is impossible without advance knowledge of what credit each institution will award for various courses. Institutions already under financial pressure and funding constraints are forced to expend valuable resources manually evaluating transcripts of incoming transfer students course by course. States attempting to maximize the benefit of educational spending at an overall system level are unable to serve the needs of their workforce and employers due to the lack of transparency and efficiency of the course articulation process and are responding with legislative mandates for an improved approach. The historic approach of attempting to build gigantic databases including correlations between every college course at every college in the country, has failed to solve the problem for 20 years and shows no sign of improvement.

Students in higher-education programs transfer from one institution to another for a variety of reasons. For example, many students begin their post-secondary education at a community college or similar institution, with intent to transfer to a four-year college later. Students also may wish to transfer institutions due to geographical relocation. There has also been a growth of dual- or concurrent-enrollment programs, in which students may take college credit courses while still in high school, and increasing availability, quality and acceptance of online courses that eliminate or reduce geographic constraints during post-secondary education. For these and other reasons, course transferability, which may be referred to as course articulation, has grown in importance as the post-secondary experience evolves in response to these factors.

When a student transfers from one institution to another, the institution to which he is transferring must determine whether and to what degree educational course credits at the student's prior institution should be accepted. The process of evaluating courses for transferability remains largely manual with individual departments responsible for making each decision.

### BRIEF SUMMARY OF THE INVENTION

Embodiments disclosed herein provide for systems and techniques for determining, manipulating, and/or providing indications of equivalence for courses at and among institutions of higher education. Embodiments may be used to calculate and assign various scores and metrics to one or more courses, to allow for more automated and more efficient evaluation of a course by an institution.

An equivalent course may be determined based upon a selected course. For example, a substantive similarity between a proposed equivalent course and the selected course may be determined based upon at least one metric such as content similarity, objective similarity, and learning outcome similarity. An equivalency score for the proposed equivalent course relative to the selected course may be generated and presented to an evaluator. The equivalency score also may be used, for example, to make automated evaluations or decisions regarding the acceptability of the proposed equivalent course such as whether to accept or reject the proposed equivalent course as an equivalent of the selected course. Additional information may be collected, such as where a response is received from an evaluator that indicates whether the equivalency score is sufficient to accept the proposed equivalent course as an equivalent of the selected course.

A substantive similarity between two courses also may be based upon the relative quality of the institution offering the proposed equivalent course, an existing global equivalency, a previous equivalency granted for an individual student transfer, or other factors. The various metrics used to determine substantive similarity also may be weighted, such as where an evaluating institution defines a relative weighting for one or more metrics. Such weightings may then be applied when the equivalency score is generated. Evaluating institutions also may provide other factors or limitations, such as where a threshold equivalency score is defined that may be used to determine whether or not the proposed equivalent course is accepted as an equivalent for the selected course. A substantive similarity may be determined based upon a content similarity, an objective similarity, and/or a learning outcome similarity.

A content similarity may be determined based upon, for example, a relative number of key words common to a published description of the proposed equivalent course and a published description of the selected course. a number of key words common to at least two descriptors such as the published description of the selected course; the published description of the proposed equivalent course; a title of the selected course; a title of the proposed equivalent course; a published description of a known equivalent course for the selected course; a title of a known equivalent course for the selected course; a published description of a second degree course; and a title of a second degree course, or other factors. The content similarity may be normalized based upon, for example, content similarities of other courses accepted as equivalent courses by an institution.

An objective similarity may be based upon a relative overlap in semantic themes between the proposed equivalent course and the selected course or, more generally, a relative overlap in semantic themes between at least two courses such as the proposed equivalent course, the selected course, a known equivalent course for the selected course, and a second degree course. The objective similarity may be normalized based upon, for example, objective similarities of other courses accepted as equivalent courses by an institution.

A learning outcome similarity may be determined based upon a degree of commonality of semantic themes between the proposed equivalent course and the selected course or, more generally, a degree of commonality of semantic themes between at least two courses such as the proposed equivalent course, the selected course, a known equivalent course for the selected course, and a second degree course. A learning outcome similarity may be normalized based upon, for example, learning outcome similarities of other courses accepted as equivalent courses by an institution.

An equivalency score generally may be determined based upon one or more of the content similarity, the objective similarity, and the learning outcome similarity. An institution may apply a relative weight to each, which is then used to generate the equivalency score. The equivalency score may be adjusted based upon additional factors, such as an institutional rigor factor associated with the institution offering the proposed equivalent course. Similarly, the degree to which a proposed equivalent course is accepted may be adjusted, such as by assigning number of credit hours to be offered for the proposed equivalent course at the institution.

Embodiments disclosed herein provide a variety of mechanisms for determining whether a proposed equivalent course is, or should be, accepted as an equivalent by an evaluating institution. For example, a relative weight for one or more metrics for a proposed equivalent course, such as a content similarity, an objective similarity, and a learning outcome similarity may be received from an evaluating institution. A substantive similarity between the proposed equivalent course and a selected course may be determined based upon one or more metrics such as a content similarity between the proposed equivalent course and the selected course, an objective similarity between the proposed equivalent course and the selected course, and a learning outcome similarity between the proposed equivalent course and the selected course. Each metric may be weighted according to a relative weight received from the evaluating institution to generate an equivalency score for the proposed equivalent course, and the equivalency score then may be compared to a predetermined threshold. The threshold may be predefined within an evaluation system, or it may be set by the evaluating institution. Based upon the comparison, an indication of whether the proposed equivalent course is an acceptable equivalent for the selected course may be provided to the evaluating institution.

Additional features, advantages, and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification; illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1A shows an example overview of a process, or group of processes, that may be used to determine whether a proposed equivalent should be accepted as an equivalent of a selected course as disclosed herein.

FIG. 1B shows an example process for analyzing content similarity when determining whether a course should be accepted as an equivalent as disclosed herein.

FIG. 1C shows an example process for analyzing equivalencies when determining whether a course should be accepted as an equivalent as disclosed herein.

FIG. 1D shows an example process for considering institution profiles when determining whether a course should be accepted as an equivalent as disclosed herein.

FIG. 2 shows an example process for generating a content similarity for a proposed equivalent of a base course as disclosed herein.

FIG. 3 shows an example process for generating an objective similarity for a proposed equivalent of a base course as disclosed herein.

FIG. 4 shows an example process for generating a learning outcome similarity for a proposed equivalent of a base course as disclosed herein.

FIG. 5 shows an example map of relationships between example proposed equivalent courses for a base course as disclosed herein.

FIG. 6 shows an example arrangement of systems for determining course equivalencies as disclosed herein.

### DETAILED DESCRIPTION OF THE INVENTION

A number of inefficiencies exist in conventional techniques for determining whether to accept prior educational course credits for transfer. The evaluation process can be very inconsistent, and may be based on individual evaluator or institution bias and philosophy. Conventional techniques involve largely manual processes, which may be slow and require many steps for a student to find out which credits will be accepted for transfer. Further, there is little or no ability for students to test potential credit transfer in a real-time feedback loop. Current software products to assist in the articulation process are generally antiquated and rely on non-scalable constructs, such as static mappings between known classes.

The present disclosure presents techniques and systems to standardize this process, and allow for increased automation and consistency in determining whether an institution will accept previously earned credits for transfer and which requirements in the students degree program at the successor institution those credit will satisfy. Generally, embodiments of the invention evaluate a potential equivalent course relative to a base course at an institution, and provide a rating that indicates the degree of correlation between the two courses. Institutions can manually or automatically select courses to accept as equivalents based upon the provided rating.

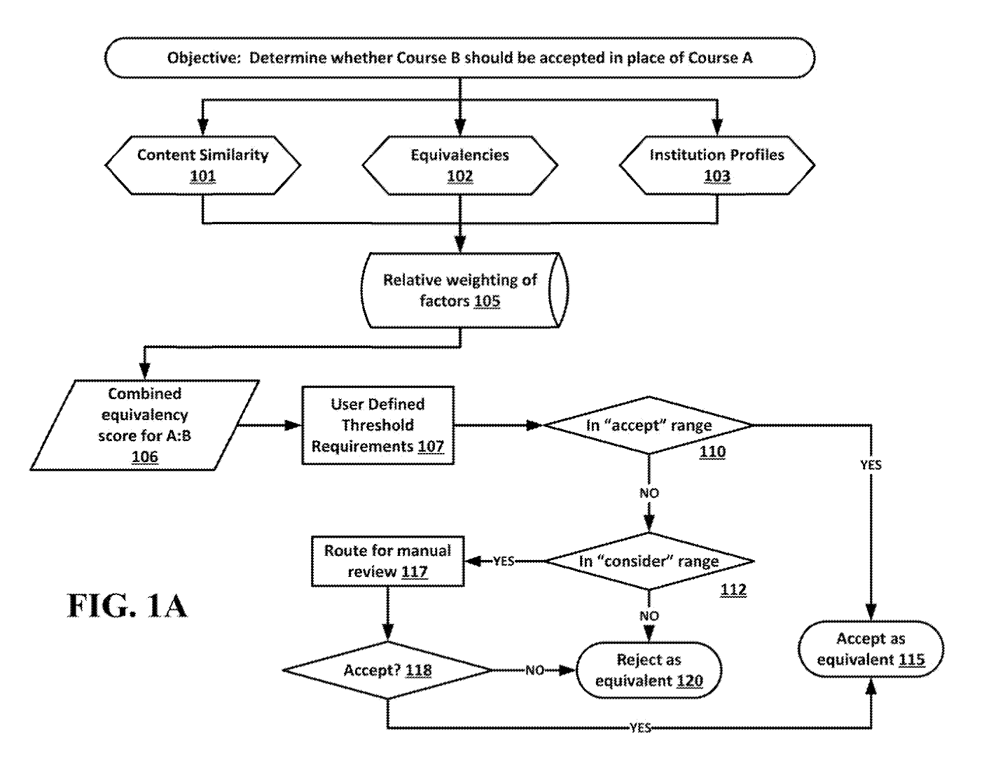

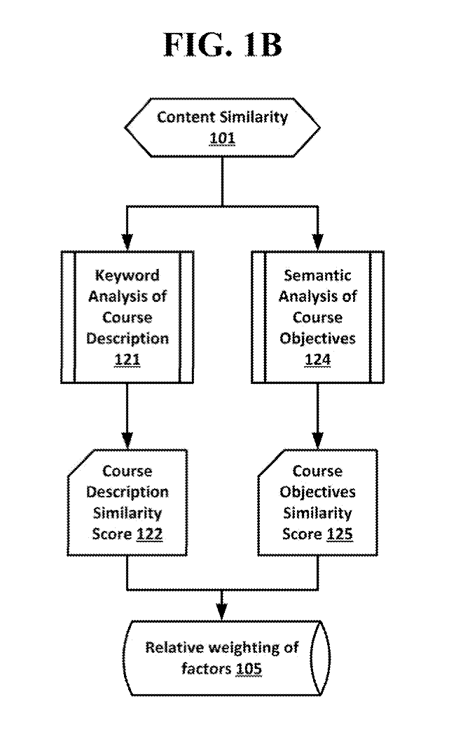

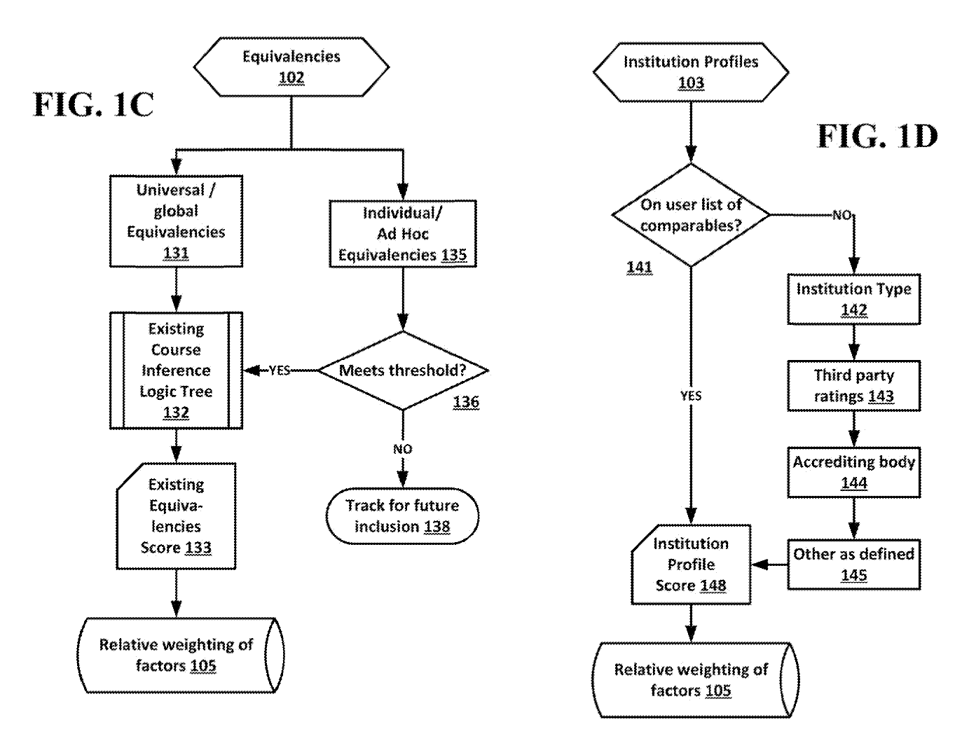

In an embodiment, a proposed equivalent course may be evaluated relative to a selected or specified course at an institution. The proposed equivalent course may be evaluated by determining a substantive similarity between a proposed equivalent course and the selected course. For example, a substantive similarity may be, or may be based upon, at least one metric such as the content similarity, objective similarity, and/or learning outcome similarity between the proposed equivalent course and the selected course. An equivalency score for the proposed equivalent course relative to the specified course may be generated based upon the substantive similarity, and presented to an evaluator for consideration. Alternatively, an automated system may identify the proposed equivalent as acceptable or not acceptable based upon threshold values for the equivalency score set by the institution. In some cases, an evaluator may provide a response that indicates whether the equivalency score is sufficient to accept the proposed equivalent course as an equivalent of the selected course. The response may be stored and used to assist in evaluation of other similar courses in the future. The equivalency score also may be in an intermediate range, which may suggest that the course should be evaluated further. For example, an institution may specify a minimum equivalency score; if a proposed equivalent course has an equivalency score at least equal to the minimum; it may avoid being rejected as an equivalent. Similarly, an institution may set an equivalency score above which a course is automatically accepted as an equivalent for the selected course. An example process as disclosed herein is shown in FIG. 1 and discussed in further detail below.

As described in further detail herein, other factors may be used to calculate an equivalency score and/or the number of credits to be given for a particular course. For example, the relative quality of the institution offering the proposed equivalent course may be considered, where an institution known to have a certain overall quality, or a certain quality for a course or department, may be more likely to have its courses accepted as equivalents. Existing global equivalencies, ad hoc or individual equivalencies, or other preexisting equivalencies also may be used.

In an embodiment, an institution may set various weights to be applied when the equivalency score is calculated. For example, an institution may specify the relative weight that should be given to the content similarity, objective similarity, and/or learning outcome similarity for a given pair of a base course and a proposed equivalent course. As a specific example, an institution may indicate that the learning outcome similarity should be weighted to be twice as important as the content and/or objective similarity for the course, in which case it will be so weighted when the equivalency score is calculated.

In an embodiment, a content similarity for a proposed course may be identified based upon the number of key words common to the proposed course and the base course or other courses. For example, key words may be identified and counted in a published description of the base course, the published description of the proposed equivalent course, the base course title, the proposed equivalent course title, the description and/or title of a known equivalent course for the base course, and a title and/or description of a known equivalent course for the base course. The content similarity may be normalized to content similarities of other courses accepted as equivalent courses by an institution, all courses accepted from the institution, or any other group of courses. As previously disclosed, a weight may be assigned to the content similarity, and/or to factors used to calculate the content similarity, to indicate its relative importance in calculating the equivalency score.

FIG. 1A shows an example overview of a process, or group of processes, that may be used to determine whether a proposed equivalent should be accepted as an equivalent of a selected course. Generally, to determine whether a proposed equivalent Course B should be accepted as an equivalent of an identified Course A, three factors may be considered: the content similarity 101 of the courses, any known equivalencies 102, and any relevant institution policies 103, as described elsewhere herein. Specific illustrative examples of each factor are provided in FIGS. 1B-1D. These factors may be combined, such as by assigning relative weights at 105, to generate an equivalency score for Course B relative to Course A at 106.

The equivalency score may be used directly to determine whether Course B should be accepted as an equivalent, such as by comparison to a set threshold at 107. In some cases, any course that has an equivalency score above the threshold may be accepted as an equivalent. In other cases, the threshold may define multiple ranges. For example, if the equivalency score is above an “accept” value at 110, it may be accepted as an equivalent at 115 immediately. If the equivalency score is below the “accept” threshold 110 but above a “consider” threshold 112, it may be conditionally accepted or otherwise routed for manual review at 117, such as by a human reviewer or a subsequent automated review 118. If the equivalency score is below the “consider” threshold 112 or if subsequent review 118 indicates that it should not be accepted, then Course B may be rejected as an equivalent of Course A at 120.

FIG. 1B shows an example process for analyzing content similarity 101 when determining whether a course should be accepted as an equivalent. As shown, a keyword analysis of the Course B course description may be performed or obtained at 121 as disclosed herein. A course description similarity score 122 may be generated, which indicates the degree of similarity between the descriptions of Course B and Course A. As disclosed in further detail herein, a semantic analysis of the course objectives of Course B also may be compared to the course objectives of Course A at 124 to generate a course objective similarity score at 125. The similarity scores may be stored and combined with other scores and analyses, such as by way of a relative weighting 105 as disclosed herein.

FIG. 1C shows an example process for analyzing equivalencies 102 when determining whether a course should be accepted as an equivalent. As shown, both universal or global equivalencies 131 and individual and/or ad hoc equivalencies 135 may be considered, as described in further detail herein. If a global equivalency exists, an existing equivalency score 133 may be assigned to Course B. An existing equivalency score may have been previously generated, such as via an existing course inference logic tree for Course B that provides a description of previously-determined equivalency information for Course B, and/or using other techniques as disclosed herein. If an individual or ad hoc equivalency exists or is generated for Course B at 135, it may be compared to a threshold for such equivalencies at 136. An equivalency meeting the threshold may then be used to generate an equivalency score at 133, and may be recorded to provide information about Course B in future equivalency analyses. If the individual or ad hoc equivalency falls below the threshold 136, Course B may be tracked for future consideration as an equivalent for Course A at 138, as disclosed herein.

FIG. 1D shows an example process for considering institution profiles 103 when determining whether a course should be accepted as an equivalent. Initially, a list of known institutions may be consulted to determine if the institution offering Course B is already recognized as providing equivalent courses in general or, more specifically, is already known to offer an equivalent to Course A, at 141. If so, an institution profile score may be obtained or generated at 148, which indicates the degree of acceptability for courses offered by the institution. If the institution is not on a list of existing comparable institutions, or similar list that indicates whether courses from the institution typically are or should be accepted as equivalents, an analysis of the institution may be performed at 142-145. For example, the institution type 142, rankings provided by third parties 143, any bodies that provide accreditation of the institution and the associated accreditations or lack thereof 144, and any other suitable information about the institution 145 may be considered. As a specific example, an accredited, highly-rated four-year institution may be given a higher profile score at 148 than a two-year institution, an unaccredited institution, or an institution that has not yet been rated by third party evaluators.

Specific examples of the various steps and processes described with respect to FIGS. 1A-1D are provided herein. It will be understood that these examples as well as the processes described in FIGS. 1A-1D are illustrative, and other processes may be used without departing from the scope of the invention disclosed herein.

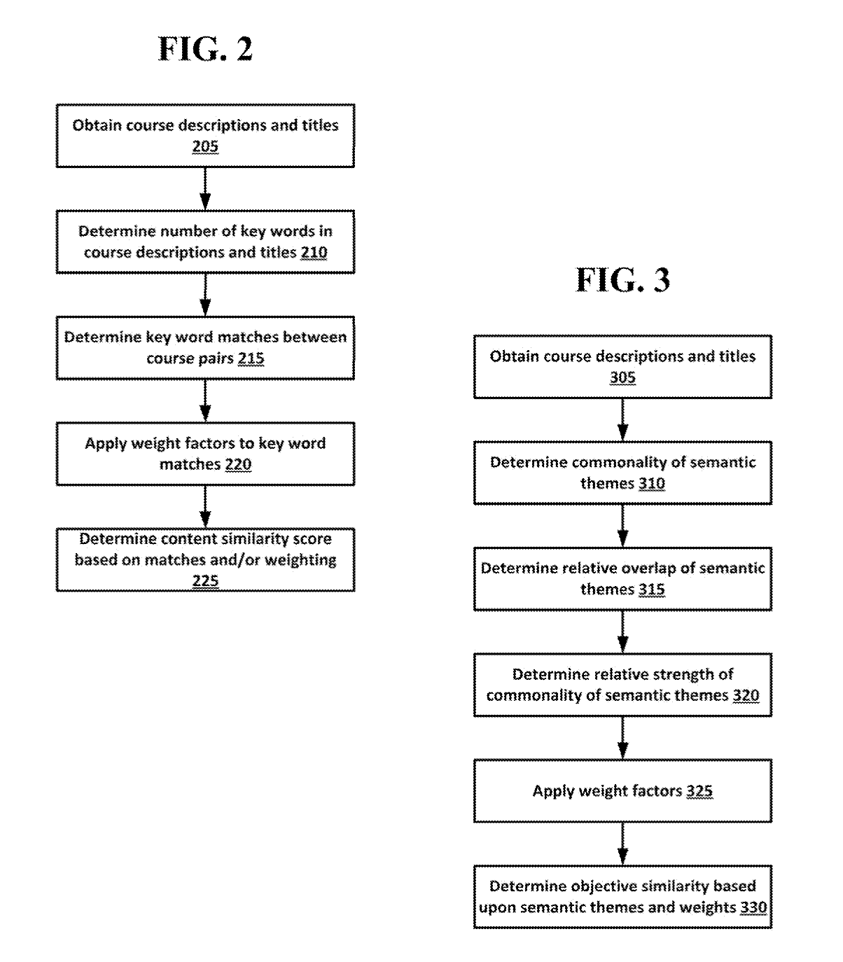

FIG. 2 shows an expanded example of a process for generating a content similarity, such as the content similarity 101 in FIGS. 1A-1D, for a proposed equivalent of a base course. As previously described, the proposed equivalent course may be, for example, a course offered by another institution, that an evaluating institution is considering as accepting as an equivalent course of a base course at the evaluating institution. At 205, course descriptions and titles may be received for a base course and a proposed equivalent course. A course description and title also may be received for one or more related courses, such as equivalent courses, 2^{nd} degree courses, and the like. Such additional courses may be used to further inform the content similarity score for the proposed equivalent course, as disclosed in further detail herein. At 210, key words in the course descriptions and titles may be determined. More specifically, the number of key words in the course description and title for the base course and the proposed equivalent course, as well as one or more equivalent courses and/or 2^{nd} degree or other related courses, may be counted. The key words may be obtained, for example, from a database of key words defined for a course, a subject, a college, a department, or the like. In some cases, the number of key words for a particular course may already be known, such as where a base course has been evaluated previously in a specific context, and the prior key word analysis results stored for further use. In addition to explicit key words, contextual synonyms also may be determined, or contextual synonyms may be considered as matches to key words when comparing between courses. For example, the terms “U.S.” and “American” may be considered as matching key words when evaluating a history course as a proposed equivalent course, even though they are not an exact key word match. Contextual synonyms also may be stored in a database or other structure storing a set list of key words.

At 215, the number of key words common to two course descriptions may be determined for one or more course pairs. Typically, the number of common key words between course descriptions and titles for the base course and the proposed equivalent course may be determined. In addition, the number of common key words between any two of the other courses for which titles and course descriptions are obtained at 205 may be determined, such as the proposed equivalent course and one or more other equivalent courses, the proposed equivalent course and one or more 2^{nd} or higher-degree courses, or combinations thereof may be determined. A weight factor may be applied to each at 220; for example, an institution may indicate that key word matches between a proposed equivalent course and a 2^{nd} degree course should be weighted at half the value of matches between the base course and the proposed equivalent course, in which case a weight factor of 0.5 may be applied. Weight factors may be applied to one or more of the number of matches obtained between course pairs.

A content similarity score for the proposed equivalent course may be obtained from the number of key words and/or number of key words that course pairs have in common. As an example, the content similarity score may be generated as the sum of the number of common key words the proposed equivalent course has with each of the other courses considered. Alternatively, the content similarity score may be calculated as a percentage of the total keywords available. Alternatively or in addition, the content score may be normalized relative to other courses at the evaluating institution.

At 225, the content similarity score may be determined based upon the number and/or percentage of common keywords for the proposed equivalent course, relative to one or more of the other courses considered. As a specific example, the total number of common keywords for each course pair may be divided by the total number of key words considered, to determine the percentage of keywords that are common keywords. These counts may be added and divided by the sum of 2 plus the number of equivalent courses considered, plus the number of 2^{nd} degree courses considered, to generate the raw number of common key words per course for the proposed equivalent course. The number and/or percentage of common keywords may be normalized, for example to a 100-point scale. The normalization may be performed based on the content similarity score of all other courses considered and/or all other courses at the evaluating institution. As a specific example, each of the number of common key words and the portion of common key words may be normalized to a common scale, and the content similarity score may be generated as the average of the normalized number of common key words, and the normalized percentage of common key words.

In an embodiment, an objective similarity as considered in FIG. 1B may be determined based upon, for example, a relative overlap in semantic themes between the proposed equivalent course and the selected course. More generally, the objective similarity may be determined based upon the relative overlap in semantic themes between the proposed equivalent course, the selected course, a known equivalent course for the selected course, a second degree course, or any combination thereof. The objective similarity may be normalized to objective similarities of other courses accepted as equivalent courses by an institution, all courses accepted from the institution, or any other group of courses. As previously disclosed, a weight may be assigned to the objective similarity, and/or to factors used to calculate the objective similarity, to indicate its relative importance in calculating the equivalency score.

At 305, course descriptions, titles, and/or other information about a base course, proposed equivalent course and, in some cases, other related courses may be obtained. For example, information about one or more other equivalent courses and/or one or more 2^{nd} or higher-degree courses may be obtained. Each course may be analyzed to identify semantic themes of the course. As used herein, a “semantic theme” refers to a group of words determined to have similar meaning based on semantic analysis of text strings. At 310, the number and strength of commonality of common semantic themes of course objectives between the proposed equivalent course and the base course, as well as any equivalent courses and/or 2^{nd} degree courses may be determined. Similarly, at 315 and 320, respectively, the relative overlap and/or strength of commonality of common semantic themes between the proposed equivalent course and base, equivalent, and/or 2^{nd} degree courses may be determined. For example, it may be determined that although two courses have a common semantic theme, the overlap between the two is minimal. Similarly, it may be determined that although the semantic themes of two courses are related, there is not a strong commonality between the two, such as where both courses relate to a basic theme common to a series of courses, but each is directed to different portions of that semantic theme. The strength of commonality of common semantic themes between the proposed equivalent course and the equivalent courses, and/or between the proposed equivalent course and 2nd degree or higher courses, may be adjusted by a specified weight factor at 325. At 330, the objective similarity may be determined based upon the relationships of semantic themes and any weighting provided to the semantic theme relationships. As a specific example, the average commonality of overlapping semantic themes, optionally excluding non-common themes, may be calculated, and the course objective similarity score determined by multiplying the average percent overlap of semantic themes by the average commonality strength of overlapping themes. A raw objective similarity score may be normalized, for example, to a 100-point scale based on the objective similarity scores of all other courses.

Other semantic analyses may be performed to determine whether a proposed equivalent course should be accepted as an equivalent course. In an embodiment, a learning outcome similarity may be determined based upon the degree of commonality of semantic themes between the proposed equivalent course and the selected course. More generally, the learning outcome similarity may be based upon the degree of commonality of semantic themes between the proposed equivalent course, the base course, a known equivalent course for the selected course, and/or a second degree course. The learning outcome similarity may be normalized to learning outcome similarities of other courses accepted as equivalent courses by an institution, all courses accepted from the institution, or any other group of courses. As previously disclosed, a weight may be assigned to the learning outcome similarity, and/or to factors used to calculate the learning outcome similarity, to indicate its relative importance in calculating the equivalency score.

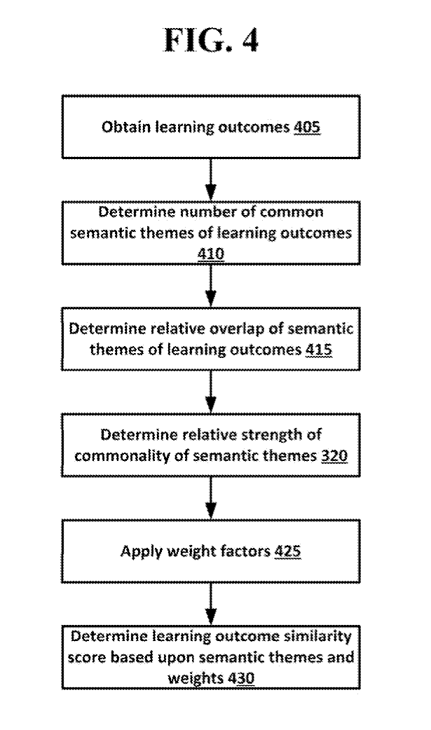

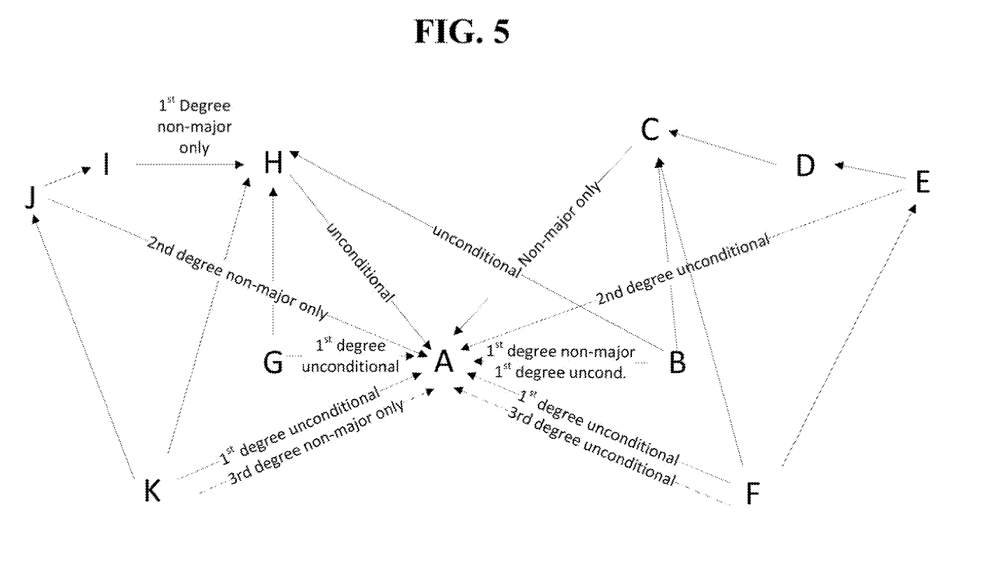

FIG. 4 shows an example process for generating a learning outcome similarity for a proposed equivalent of a base course. At 405, learning outcomes for semantic themes of a base course, a proposed equivalent course, one or more equivalent courses, and/or one or more 2^{nd} degree courses may be obtained. The learning outcomes may be obtained from course data such as course descriptions, institutionally-defined learning outcomes, standards-based learning outcomes, or the like. Similar to the processes described with respect to FIGS. 3, at 410 and 415, respectively, the number and strength of commonality of common semantic themes, and the relative overlap of common semantic themes of learning outcomes between the proposed equivalent course and the base course may be determined, as well as the number and strength of commonality of common semantic themes of learning outcomes of any equivalent courses and/or 2^{nd} degree courses considered. At 420 and 425, respectively, the strength of commonality of common semantic themes and the relative overlap thereof, between the proposed equivalent course and equivalent courses and/or 2^{nd} degree courses, may be adjusted by a weighting factor. A learning outcome similarity score may then be generated based upon the commonality, strength of commonality, and/or the relative overlap of common semantic themes of learning outcomes may then be generated at 430. As a specific example, the average commonality of overlapping semantic themes, optionally excluding non-common themes, may be determined, and may be multiplied by the average percentage overlap of themes to obtain a raw learning outcome similarity score. The learning outcome similarity score may be normalized, for example to a 100-point scale, based on the Learning Outcome Similarity scores of all courses.

As previously described with respect to FIG. 1, a course similarity score may be generated based upon various factors such as a course description similarity score, one or more objective similarity scores, one or more equivalency scores, an institution profile score, or the like. In some cases, additional adjustments may be made to a course similarity score based upon additional information or generated values.

In an embodiment, a course similarity score may be adjusted depending on whether the course is being considered for general credit or for in-major credit. For example, an in-major factor may be used to weigh the course appropriately depending on whether it is to be used for in-major credit or not, such as where a general physics course is considered similar to other general physics classes for general credit, but is considered “less similar” to an introductory physics class intended for physics majors as a requirement for a physics degree. Such an adjustment may be made by applying an additional weighting to one or more previously-calculated scores. As a specific example, a course similarity score may be determined by calculating a weighted average content similarity score for general credit for the base course and a proposed equivalent course, as previously described. Each of the content similarity score, the objective similarity score, and the learning outcome similarity score may be multiplied by an appropriate weighting. These values may then be summed and divided by an in-major factor to derive a weighted average content similarity score for major credit, based upon the scores initially calculated for general credit. For example, it may be determined that a particular course should be twice as “similar” for in-major purposes as for general credit purposes, in which case a weight of “2” may be assigned.

In some cases, it may be desirable to adjust the amount or level of credit given to an equivalent course. In an embodiment, the amount or level of credit that is given to a course considered an equivalent of a base course may be determined at least partially by the known rigor or other rating of the institution that offers the proposed equivalent course. For example, an institutional rigor factor as previously described with respect to FIG. 1D may be assigned to each institution from which potential course equivalencies are to be considered. As a specific example, the credit offered may be adjusted based upon an institutional rigor factor by compiling a table of institutional rigor factors such as type of institution (4 year, 2 year, national university, public/private/for-profit, etc.), accrediting bodies, published ratings, graduation rates, and the like. A default value may be assigned to each factor based on the relative importance of the factor, for example as defined by the evaluating institution. In some cases, the relevant college or department may be allowed to adjust factors as desired, such as where a particular department only wishes to offer full transfer credit for courses taken at a four-year, national, accredited institution with a minimum threshold graduation rate within a major appropriate for the department. A raw institutional rigor score may be calculated by adding the assigned value for all relevant factors for each institution. The score may be normalized, for example based on the overall population of the institution. A ratio for relative institutional rigor between the evaluating institution and the teaching institution may be assigned. In some cases, an evaluating institution may be allowed to provide a cap for the ratio, such as where the institution wishes to specify that the rigor score for a teaching institution cannot be greater than 130% of the rigor score for the evaluating institution for course level or credit purposes.

Similarly, the amount and/or level of credit may be adjusted. As a specific example, the course credits/hours for the proposed equivalent course may be multiplied by the ratio of relative institutional rigor as previously described, to calculate an equivalent course credit/hours of the proposed equivalent course for non-major course credit. The numeric course level of the proposed equivalent course may be multiplied by the relative rigor ratio as previously described, to determine an equivalent course level for the proposed equivalent course as an equivalent for the base course. The equivalent course level may be rounded down, i.e., to the next course level threshold, to determine a maximum course level for the proposed equivalent course for non-major course credit. The course level also may be adjusted for major credit, such as by multiplying the equivalent course level by the in-major factor as previously described to determine the equivalent course level of the proposed equivalent course for major credit. The equivalent course credit/hours of the proposed equivalent course may be multiplied by an in-major factor to determine the equivalent course hours of the proposed equivalent course to the base course for major credit, to calculate an equivalent course credit of the proposed equivalent course for non-major course credit.

As previously described with respect to FIG. 1C, course equivalencies may be used to generate an equivalency score for a proposed equivalent course. In an embodiment, existing global course equivalencies (courses which are already approved as substitutes for other courses) may be used to suggest the likelihood of equivalency between a base course and a proposed equivalent course when no such direct global course equivalency currently exists between the specific base course and a proposed equivalent course. The global equivalencies also may be used to normalize credit granted toward program of study requirement or general studies requirement. As a specific, illustrative example, a list of global equivalencies may be generated for each global equivalency for a base course (first degree course equivalents), and classified as either program of study or general studies credit. Similarly, a list of global equivalents for each first degree course equivalent (i.e., second degree course equivalents) may be generated and classified as either program of study or general studies. Similarly, a list of global equivalents for each second degree course equivalent (third degree course equivalents) may be generated and classified as either program of study or general studies only. Each list may be generated, for example, based upon stored equivalents that have previously been identified, suggested, and/or accepted by the evaluating institution. A college, department, or the like may determine a degree of confidence in other institutions, which may be included in equivalency comparisons. The degree of confidence may be assigned directly, or it may be automatically determined such as based upon the type, rigor score, explicit list, or the like of teaching institutions. For example, the institution profile score as previously described may be used. The degree of confidence may be used to filter equivalents on the generated list, such as where only equivalents from an institution having a threshold confidence score are accepted or considered when identifying global equivalents.

As previously described with respect to FIG. 1C, ad hoc equivalencies (i.e., equivalencies granted on a student-by-student basis) may be used in addition to global equivalencies to determine the likelihood of equivalency between a base course and a proposed equivalent course, and/or to normalize credit granted toward program of study requirement or general studies requirement. For example, the number of times that a course has been granted equivalency in similar circumstances may be considered when first evaluating a new course as a potential equivalent course. As a specific illustrative example, equivalencies granted for individual students for degree credit audit based on individual institutional policies may be captured and recorded, such as by maintaining a record of ad hoc equivalencies granted by major and category. This information may be compiled in ad hoc equivalency database to allow for rapid determination if an equivalency should be granted based upon a prior similar equivalency. Default parameters may be established, such that ad hoc equivalencies become global equivalencies when certain criteria are met. The criteria may be based on factors such as the number of times equivalency has been granted (for major and/or non-major credit), the recency of an ad hoc equivalency grant, an indication by the faculty of a confidence level in an ad hoc grant (e.g., whether the grant should due only to exceptional circumstances or generally applicable), or the like. Generally, an institution may be provided with a mechanism to revise default parameters, such as based on institutional policy regarding transfer credits or other policies. Once ad hoc equivalencies are generalized to global equivalencies, they may be added to the calculation previously described, using existing equivalencies to determine an equivalency between a base course and a proposed equivalent course.

In an embodiment, equivalency points may be assigned to various courses, based upon their suitability to transfer credits as an equivalent to a base course. Generally, lower point values are assigned to higher-degree course equivalents. For example, second degree equivalents may be assigned a lower number of points than first degree equivalents, and so on. The equivalency point value for a particular course may provide a relative indication of how “close” the course is to a base course for purposes of credit transfer. The equivalency point value assigned to a course may be considered in a process as disclosed with respect to FIG. 1, or it may be used directly to determine whether a proposed equivalent course is to be accepted as an equivalent of a base course. As a specific example, equivalency points may be calculated as shown and described below:

| Course Type | Example Point Rule(s) | Example |
|---|---|---|
| First Degree Equivalent | 100% | 100 |
| Second Degree Equivalent | <100% | 75 |
| Third Degree Equivalent | <100%, <2^{nd} Degree | 50 |

For example, an initial point value may be assigned to any first degree course equivalent, whether unconditional, non-major only, or the like. A point value less than 100% of the first degree course equivalent value may be assigned to each second degree course equivalent and Third degree course equivalent. Higher-order equivalents also may be assigned relative to their order, such as where a third degree equivalent is always assigned a point value less than a second degree equivalent. The point values for all first, second and third degree equivalents may be added, distinguishing between unconditional/in major and non-major only/general studies credits. The total equivalency points for a proposed equivalent course relative to the base course categorized as unconditional/in major and non-major only/general studies credits may then be provided. The unconditional percentage of total equivalency points also may be provided as a relative point score.

FIG. 5 shows an example map of a variety of proposed equivalent courses B-K for a base course A, with corresponding relationships as disclosed herein. For example, Course K is identified as a first degree course equivalent unconditionally relative to Course A, and as a third degree equivalent for non-major credit only. Other relationships are also shown, which demonstrate the various equivalents that may be identified and tracked as disclosed herein. For example, Course B is identified as an unconditional equivalent of Course H. Such relationships may allow, for example, Course B to be identified as an equivalent of Course A when only information about the relationships between Courses A and H, and courses H and B, is known.

In the example shown in FIG. 5, various points may be assigned to the equivalencies as previously described. As a specific example, the following point scale may be used:

| Course Type | Example Point Scale |
|---|---|
| First Degree Equivalent | 10 |
| Second Degree Equivalent | 6 |
| Third Degree Equivalent | 2 |

Following the example relationships shown in FIG. 5, the resulting equivalency points for each course as a presumed equivalent for Course A is:

| Course | Points | Source |
|---|---|---|
| Course B | 20 | 10 non-major only |
| | | 10 unconditional |
| Course D | 10 | non-major only |
| Course E | 6 | non-major only |
| Course F | 12 | non-major only |
| Course G | 10 | 10 unconditional |
| Course I | 10 | non-major only |
| Course J | 6 | non-major only |
| Course K | 12 | 10 unconditional |
| | | 2 non-major only |

An institution may determine outcomes for equivalency determination based on the number of existing equivalency points between a base course and a proposed equivalent course, either as an absolute value or relative to the overall course population. Similarly, an institution may determine outcomes for major vs. program of study credit based on the relative fraction of existing equivalency points that are associated with general studies credit vs. a specific program of study credit (either absolute or relative to overall course population).

Various user interfaces may be used to access the systems and techniques disclosed herein. For example, an institution may have institution-level, student-level, and/or employee-level interfaces. An institution-level interface may provide information such as Confidence level (composite likelihood that courses should be equivalent); default decision criteria (e.g., overall guidelines to accept, review or decline a Proposed Equivalent Course as a substitute for Base Course (in major or general credit specific)); Individual Course Confirmation (affirmation by institution of a recommendation); course overrides; detailed review; equivalents mapping for base/proposed equivalencies. In an embodiment, a student interface may display different data, such as an individual course transfer evaluation; degree pathing information (e.g., options to satisfy degree requirements based on target schools ranked by criteria (cost, time to degree, etc.); equivalent courses based on search criteria (college, course type, location; equivalent course, returns base courses, etc.); transcript; earned credentials and credentials within x credits of being earned with remaining credits needed; and other similar data.

Various data sources may be used and/or maintained as part of, and/or in conjunction with, the features disclosed herein. For example, when evaluating key word matches between courses, a table of equivalent words (contextual synonyms) may be used. Tables of existing and newly-created global, ad hoc, individual, or other equivalencies also may be stored, such as in an equivalency database. These equivalencies then may be used as disclosed herein.

Other data sources may be used, such as a subject list that compiles subjects from all available institution course data, which may be grouped based on equivalent words. A list of key word groupings by subject matter may be stored, which may be derived, for example, by performing key word analysis for all courses and grouping keyword equivalent groups by reported subject for the courses. A table of elimination words may be derived and maintained as words that appears in a set minimum of course descriptions. A table of equivalent key words by course may be maintained, which may be derived, for example, by removing elimination words from course descriptions, such as before determining the number of key words that a base course and a proposed equivalent course have in common. A course classification table may describe relationships between course numbers and course levels (e.g., survey, foundation, advanced, and the like). A table of in-major factors may provide, such as for each institution, an in-major factor that describes the degree of additional rigor and/or content matching required for a course to be an equivalent for credit toward a student's major as opposed to a general studies or similar credit. For example, an institution may specify that a course must be ⅓ more rigorous to count toward major requirements. This may allow institutions to customize major factor on a global, department, subject or major basis.

It will be apparent to one of skill in the art the data sources specifically listed herein are not intended to be exhaustive or necessarily exclusive from one another. For example, entries in a subject list may overlap with those in a table of equivalent words. In addition, the data sources disclosed herein may be modified or omitted without departing from the scope of the invention.

An example calculation of equivalent transfer credits according to an embodiment is shown below. It will be understood that the particular base values provided are illustrative only, and, in general, may be scaled or assigned arbitrarily. Where different values may be used, consistent equivalency scores may be obtained through normalization or similar processes.

| | Base | Teaching | Evaluating |
|---|---|---|---|
| | Values | IHE | IHE |
| 4 year national | 35 | | |
| university | | | |
| 4 year national | 30 | | |
| liberal arts | | | |
| 4 year regional | 25 | | |
| university | | | |
| 4 year regional | 20 | 20 | |
| college | | | |
| 2 year private | 10 | | |
| 2 year public | 10 | | 10 |
| For profit | 5 | | |
| National | 20 | 20 | 10 |
| accreditation | | | |
| Regional | 10 | | |
| accreditation | | | |
| Total raw | | 40 | 20 |
| score | | (20 + 20) | (10 + 10) |
| Normalized to | | 70 | 45 |
| 100 point scale | | | |
| for all IHE's | | | |
| Relative rigor | | 156% | |
| ratio | | (70/45) | |
| Base Course | 200 | | |
| Level | | | |
| Proposed | 300 | | |
| Course | (200*156%) | | |
| equivalent | | | |
| transfer level- | | | |
| general credit | | | |
| In-major factor | 1.2 | | |
| Proposed | 259.2593 | | |
| Course | (156%*200/1.2) | | |
| equivalent | | | |
| transfer level- | | | |
| major credit | | | |

The following terms and definitions are used herein. It will be understood that similar and other terms may be used in the art to describe concepts used in the present disclosure.

A “Base Course” refers to a course for which a substitute course is being considered.

An “Equivalent Course” refers to a course which is accepted by an Evaluating IHE as a substitute for a Base Course.

A “Proposed Equivalent Course” refers to a course being evaluated as a substitute for a Base Course.

A “2nd degree course” refers to a course which is accepted by an Evaluating IHE as a substitute for an Equivalent Course.

An “Evaluating IHE” or “evaluating institution” refers to a college or other institution that decides whether to give base course credit for an Equivalent Course. More generally, an “institution” may refer to a college, university, department, school, or a logical or administrative subdivision thereof, and an “evaluating institution” refers to an institution that decides or is deciding whether to give course credit for an Equivalent Course or other identified course, in place of an identified course at the evaluating institution.

A “Teaching IHE” or “teaching institution” refers to an institution that offers an Equivalent Course or Proposed Equivalent Course.

A “2nd degree IHE” or “2nd degree institution” refers to an institution that offers a second degree course.

“Content similarity” refers to the extent to which a Base Course and an Equivalent Course covers the same subject matter.

“Objective similarity” refers to the extent to which a Base Course and an Equivalent Course seeks or are designed to achieve the same course objectives.

“Learning outcome similarity” refers to the extent to which a Base Course and an Equivalent Course seeks or are designed to achieve the same learning outcomes.

“Contextual synonyms” are words with substantially similar meanings within the context of specific subject matter (e.g., law and legal).

“Key Words” are words in a course description that are specific to the course's content, in contrast to course descriptions that may be common across different subject matter.

“Semantic Themes” are groups of words determined to have similar meaning based on semantic analysis of text strings.

“Existing global equivalency for major credit” refers to courses that are classified by an Evaluating IHE as unconditional equivalents for a Base Course in satisfying requirements for a program of study. “Existing global equivalency for general studies credit” refers to courses that are classified by an Evaluating IHE for general studies credit toward overall credit hour requirements, but may not be accepted to satisfy specific requirements for program of study. Existing global equivalency courses may be published by an institution, or may be maintained privately.

“Ad Hoc equivalency for major credit” refers to a course that is accepted by an Evaluating IHE for a specific student as equivalent for a Base Course in satisfying requirements for a program of study. “Ad Hoc equivalency for general studies credit” refers to a course that is accepted by an Evaluating IHE for a specific student for general studies credit toward overall credit hour requirements, but may not be accepted to satisfy specific requirements for program of study. “Ad Hoc” equivalencies may be determined on a case-by-case basis, and may or may not follow existing global equivalencies. “Ad Hoc” equivalencies may be published by an institution, or may be maintained privately.

A “first degree course equivalent” refers to a course that is an equivalent for an equivalent of a Base Course. For example, if Course A is a recognized equivalent for Course B, and Course B is a recognized equivalent for Course C, then Course C is a first degree equivalent for Course A. Similarly, a “second degree course equivalent” refers to a course that is an equivalent for a first degree equivalent of a Base Course.

An “equivalency database” refers to a collected record of previously-determined equivalencies. An equivalency database may store a record of each type of equivalency, and may note the type of equivalency in the associated record.

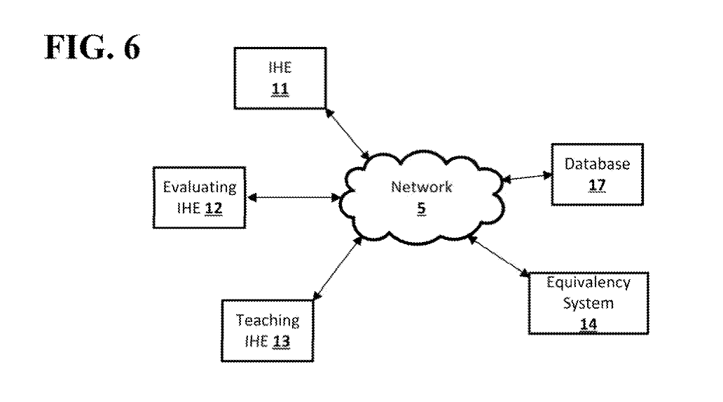

FIG. 6 shows an example arrangement of systems suitable for use with the present invention. One or more IHEs 11, 12, 13 may be in communication with an equivalency system 14 and a database 17, which together may perform the various functions disclosed herein. Each IHE 11, 12, 13, may be an evaluating IHE 12 or a teaching IHE 13 at different times and for different evaluations of courses as disclosed herein. Each IHE may access the equivalency system 14 via a communication network 5, such as the Internet, a local network, a wide-area network, or the like. The equivalency system 14 may generate equivalency scores and other measures as disclosed herein, and provide indications of equivalence to an IHE or other entity as disclosed. In some cases, the equivalency system may be specific to an IHE, or it may be a central system that provides services to multiple IHEs, such as by way of a subscription service or the like. The equivalency system 14 and associated database 17 may be implemented on one or more computer systems, each of which may have appropriate input and output data channels to communicate with the IHEs and other entities, as will be readily understood by one of skill in the art.

Various embodiments of the presently disclosed subject matter may include or be embodied in the form of computer-implemented processes and apparatuses for practicing those processes, including individual computers, networked computer systems, parallel and serial processing systems, and the like. More generally, any computing device or system may be used to implement embodiments of the disclosed subject matter, and may be converted to special-purpose systems for implementing embodiments of the disclosed subject matter, such as by executing computer code constructed to effectuate those embodiments. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

What is claimed is:

1. A computer-implemented method comprising:
receiving, from an evaluating institution, a relative weight for at least one metric selected from the group consisting of: a content similarity, an objective similarity, and a learning outcome similarity;
determining a substantive similarity between a proposed equivalent course and a selected course, the substantive similarity being based upon at least one metric selected from the group consisting of: a content similarity between the proposed equivalent course and the selected course, an objective similarity between the proposed equivalent course and the selected course, and a learning outcome similarity between the proposed equivalent course and the selected course;
weighing each of the determined metrics according to the relative weight received from the evaluating institution to generate an equivalency score for the proposed equivalent course;
comparing the equivalency score to a predetermined threshold; and
based upon the comparison, providing an indication of whether the proposed equivalent course is an acceptable equivalent for the selected course to the evaluating institution.

2. A method as recited in claim 1, further comprising a step of determining the content similarity based upon a relative number of key words common to a published description of the proposed equivalent course and a published description of the selected course.

3. A method as recited in claim 1, further comprising a step of determining the content similarity based upon a number of key words common to at least two descriptors selected from the group consisting of: the published description of the selected course; the published description of the proposed equivalent course; a title of the selected course; a title of the proposed equivalent course; a published description of a known equivalent course for the selected course; a title of a known equivalent course for the selected course; a published description of a second degree course; and a title of a second degree course.

4. A method as recited in claim 3, further comprising a step of normalizing the content similarity based upon content similarities of other courses accepted as equivalent courses by an institution.

5. A method as recited in claim 1, further comprising a step of determining the objective similarity based upon a relative overlap in semantic themes between the proposed equivalent course and the selected course.

6. A method as recited in claim 1, further comprising a step of determining the objective similarity based upon a relative overlap in semantic themes between at least two courses selected from the group consisting of: the proposed equivalent course, the selected course, a known equivalent course for the selected course, and a second degree course.

7. A method as recited in claim 6, further comprising a step of normalizing the objective similarity based upon objective similarities of other courses accepted as equivalent courses by an institution.

8. A method as recited in claim 1, further comprising a step of determining the learning outcome similarity based upon a degree of commonality of semantic themes between the proposed equivalent course and the selected course.

9. A method as recited in claim 1, further comprising a step of determining the learning outcome similarity based upon a degree of commonality of semantic themes between at least two courses selected from the group consisting of: the proposed equivalent course, the selected course, a known equivalent course for the selected course, and a second degree course.

10. A method as recited in claim 9, further comprising a step of normalizing the learning outcome similarity based upon learning outcome similarities of other courses accepted as equivalent courses by an institution.

11. A method as recited in claim 1, further comprising determining the substantive similarity based upon the content similarity, the objective similarity, and the learning outcome similarity.

12. A computer system comprising:
a database storing course data for a plurality of courses including a proposed equivalent course and a base course; and
a processor configured to:
determine a substantive similarity between the proposed equivalent course and the base course, the substantive similarity being based upon at least one metric generated fro the course data and selected from the group consisting of: content similarity, objective similarity, and learning outcome similarity; and
based upon the substantive similarity, generate an equivalency score for the proposed equivalent course relative to the selected course; and
an output communication component configured to provide the equivalency score to an evaluator.

13. A computer system as recited in claim 12, said computer system configured to accept the proposed equivalent course as an equivalent of the base course based upon the equivalency score.

14. A computer system as recited in claim 12, said computer system further configured to reject the proposed equivalent course as an equivalent of the base course based upon the equivalency score.

15. A computer system as recited in claim 12, said computer system further configured to identify the proposed equivalent course for further consideration as an equivalent of the base course based upon the equivalency score.

16. A computer system as recited in claim 12, said database further storing a relative weighting of each metric; and said processor further configured to apply the relative weighting when generating the equivalency score.

17. A computer system as recited in claim 12, said database further storing a threshold equivalency score value received from an evaluating institution; and said processor further configured to automatically determine whether to accept the proposed equivalent course as an equivalent for the base course based upon the threshold equivalency score value.

18. A computer system as recited in claim 12, said processor further configured to determine the substantive similarity based upon the content similarity, the objective similarity, and the learning outcome similarity.

19. A computer system as recited in claim 18, said database further storing a relative weight for each of the content similarity, the objective similarity, and the learning outcome similarity received from an institution; and said processor further configured to apply the received weight for each of the content similarity, the objective similarity, and the learning outcome similarity to generate the equivalency score.

20. A computer system as recited in claim 12, said database further storing a record indicating that the proposed equivalent course is accepted as an equivalent of the base course.

21. A computer system as recited in claim 12, said database further storing a record indicating that the proposed equivalent course is rejected as an equivalent of the base course.

22. A computer system comprising:
a database storing a relative weight for at least one metric selected from the group consisting of: a content similarity, an objective similarity, and a learning outcome similarity, the at least one metric received from an evaluating institution; and
a processor configured to:
determine a substantive similarity between a proposed equivalent course and a base course, the substantive similarity being based upon at least one metric selected from the group consisting of: a content similarity between the proposed equivalent course and the base course, an objective similarity between the proposed equivalent course and the base course, and a learning outcome similarity between the proposed equivalent course and the base course;
weigh each of the determined metrics according to the relative weight stored in the database to generate an equivalency score for the proposed equivalent course; and
compare the equivalency score to a predetermined threshold; and
a data output configured to provide an indication of whether the proposed equivalent course is an acceptable equivalent for the selected course to the evaluating institution based upon the comparison.

23. A computer system as recited in claim 22, said processor further configured to determine the content similarity based upon a relative number of key words common to a published description of the proposed equivalent course and a published description of the base course.

24. A computer system as recited in claim 22, said processor further configured to determine the content similarity based upon a number of key words common to at least two descriptors selected from the group consisting of: the published description of the base course; the published description of the proposed equivalent course; a title of the base course; a title of the proposed equivalent course; a published description of a known equivalent course for the base course; a title of a known equivalent course for the base course; a published description of a second degree course; and a title of a second degree course.

25. A computer-readable medium storing a plurality of instructions which, when executed by a processor, cause the processor to:
determine a substantive similarity between a proposed equivalent course and the selected course, the substantive similarity being based upon at least one metric selected from the group consisting of: content similarity, objective similarity, and learning outcome similarity;
based upon the substantive similarity, generate an equivalency score for the proposed equivalent course relative to the selected course; and
present the equivalency score to an evaluator.

26. A computer-readable medium storing a plurality of instructions which, when executed by a processor, cause the processor to:
receive, from an evaluating institution, a relative weight for at least one metric selected from the group consisting of: a content similarity, an objective similarity, and a learning outcome similarity;
determine a substantive similarity between a proposed equivalent course and a selected course, the substantive similarity being based upon at least one metric selected from the group consisting of: a content similarity between the proposed equivalent course and the selected course, an objective similarity between the proposed equivalent course and the selected course, and a learning outcome similarity between the proposed equivalent course and the selected course;
weight each of the determined metrics according to the relative weight received from the evaluating institution to generate an equivalency score for the proposed equivalent course;
compare the equivalency score to a predetermined threshold; and
based upon the comparison, provide an indication of whether the proposed equivalent course is an acceptable equivalent for the selected course to the evaluating institution.
